(19) United States
(12) Patent Application Publication
(10) Pub. No.: US 2023/0382383 A1
(43) Pub. Date: Nov. 30, 2023

(54) DRIVING ASSISTANT APPARATUS AND CONTROL METHOD THEREOF

(71) Applicant: HYUNDAI MOBIS CO., LTD., Seoul (KR)

(72) Inventors: Woo Hyun HWANG, Yongin-si (KR); Young Ju LEE, Yongin-si (KR)

(73) Assignee: HYUNDAI MOBIS CO., LTD., Seoul (KR)

(21) Appl. No.: 18/083,758

(22) Filed: Dec. 19, 2022

(30) Foreign Application Priority Data
May 27, 2022 (KR) 10-2022-0065142
May 27, 2022 (KR) 10-2022-0065145

(51) Int. Cl. B60W 30/17; B60W 10/18; B60W 40/08; B60W 50/08; B60W 40/10; B60W 30/182

(52) U.S. Cl. CPC B60W 30/17; B60W 10/18; B60W 40/08; B60W 50/085; B60W 40/10; B60W 30/182; B60W 2530/00; B60W 2552/00

(57) ABSTRACT

A method of controlling a driving assistant apparatus is provided, the method including: a detection step of detecting driving information of a surrounding vehicle and driving information of a host vehicle; a scenario deciding step of determining a driving state of the host vehicle using the driving information of the surrounding vehicle and the driving information of the host vehicle, and determining the driving state of the host vehicle is decided as a preset scenario of preset scenarios; a control method deciding step of setting a target acceleration of the host vehicle in response to determination that the driving state of the host vehicle is decided as the preset scenario, and determining a control method for driving control and braking control of the host vehicle following the target acceleration; and a control step of controlling the host vehicle based on the determined control method.

### CROSS-REFERENCE TO RELATED APPLICATIONS

The present application is based on and claims the benefit of priority to Korean Patent Applications Number 10-2022-0065142, filed on May 27, 2022 and Number 10-2022-0065145, filed on May 27, 2022 in the Korean Intellectual Property Office, the entire disclosure of which is incorporated herein by reference.

### TECHNICAL FIELD

The present disclosure relates to driving assistant apparatus and control method thereof.

### BACKGROUND

The content described in this section merely provides background information on the present disclosure and does not constitute the prior art.

An autonomous driving apparatus is an apparatus that recognizes a surrounding situation and the condition of a vehicle to enable the automatic driving of the vehicle to a preset destination. The autonomous driving apparatus includes the steps of recognizing the surrounding situation, determination, generating a course, and controlling the vehicle.

An existing autonomous driving apparatus merely controls to follow a target acceleration if the target acceleration is set, when a Smart Cruise Control (SCC) function is performed.

If the autonomous driving apparatus controls the vehicle to simply follow the target acceleration, the driving state of the vehicle may not be smooth and may cause inconveniences. For example, in the case of an experienced driver, when it is determined that a distance between a driving vehicle and a vehicle ahead remains long, an accelerator pedal may be first released, and then braking may be applied after waiting. However, in the conventional SCC function, once a braking target is generated, the vehicle is controlled according to the braking target, thereby causing awkward control.

### SUMMARY

In view of the above, the present disclosure provides a driving assistant apparatus which does not simply follow acceleration but provides comfort as if an experienced driver is driving a vehicle and can improve safety and fuel efficiency.

The problems to be solved by the present disclosure are not limited to the above-mentioned problems, and other problems which are not mentioned will be clearly understood by those skilled in the art from the following description.

According to an embodiment of the present disclosure, a method of controlling a driving assistant apparatus is provided, the method including: a detection step of detecting driving information of a surrounding vehicle and driving information of a host vehicle (hereinafter referred to as a ‘vehicle’); a scenario deciding step of determining a driving state of the vehicle using the driving information of the surrounding vehicle and the driving information of the vehicle, and deciding the driving state of the vehicle as one of preset scenarios; a control method deciding step of setting a target acceleration of the vehicle in response to the scenario decided in the scenario deciding step, and determining a control method for driving control and braking control of the vehicle following the target acceleration; and a control step of controlling the vehicle based on the control method decided in the control method deciding step.

According to an embodiment of the present disclosure, a driving assistant apparatus is provided, the apparatus comprising: a detection unit for detecting driving information of a surrounding vehicle and driving information of a host vehicle (hereinafter referred to as a ‘vehicle’); a scenario decision unit for determining a driving state of the vehicle using the driving information of the surrounding vehicle and the driving information of the vehicle, and deciding the driving state of the vehicle as one of preset scenarios; a control method decision unit for setting target acceleration of the vehicle in response to the scenario decided by the scenario decision unit, and determining a control method for driving control and braking control of the vehicle following the target acceleration; and a control unit for controlling the vehicle based on the control method decided by the control method decision unit.

According to an embodiment of the present disclosure, a driving assistant apparatus has the effect of enhancing competitiveness by improving the marketability of an SCC function.

### BRIEF DESCRIPTION OF THE DRAWINGS

FIG. 1 is a block diagram showing a driving assistant apparatus according to an embodiment of the present disclosure.

FIG. 2 is a flowchart showing a control method of a driving assistant apparatus according to an embodiment of the present disclosure.

FIG. 3 is a table showing a specific embodiment of the driving assistant apparatus according to an embodiment of the present disclosure.

FIG. 4 is a block diagram showing the configuration of a driving assistant apparatus according to another embodiment of the present disclosure.

FIG. 5 is a diagram illustrating a method of deciding a driving schedule of a vehicle according to another embodiment of the present disclosure.

FIG. 6 is a flowchart showing a control method of a driving assistant apparatus according to another embodiment of the present disclosure.

### REFERENCE NUMERALS

1: driving assistant apparatus
11: detection unit
12: scenario decision unit
13: control method decision unit
14: control unit

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

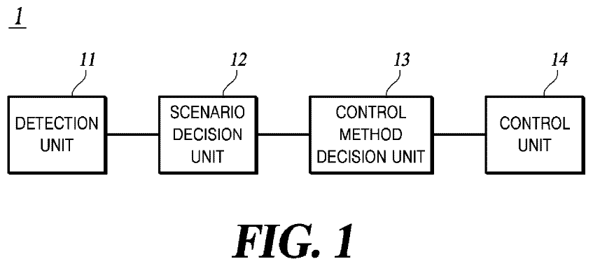

FIG. 1 is a block diagram showing a driving assistant apparatus according to an embodiment of the present disclosure.

Referring to FIG. 1, the driving assistant apparatus 1 according to an embodiment of the present disclosure may include all or some of a detection unit 11, a scenario decision unit 12, a control method decision unit 13, and a control unit 14. According to an exemplary embodiment of the present disclosure, the driving assistant apparatus 1 may include a processor (e.g., computer, microprocessor, CPU, ASIC, circuitry, logic circuits, etc.) and an associated non-transitory memory storing software instructions which, when executed by the processor, provides the functionalities of the detection unit 11, the scenario decision unit 12, the control method decision unit 13, and a control unit 14. Herein, the memory and the processor may be implemented as separate semiconductor circuits. Alternatively, the memory and the processor may be implemented as a single integrated semiconductor circuit. The processor may embody one or more processor(s).

An existing driving assistant apparatus merely controls to follow target acceleration if the target acceleration is set, when a Smart Cruise Control (SCC) function is performed. However, if the vehicle is controlled to simply follow the target acceleration, it is difficult to control the vehicle like an experienced driver. For example, the vehicle simply follows the target acceleration, thus causing awkward control such as stopping the vehicle in advance or approaching slowly.

The driving assistant apparatus 1 of the present disclosure may control the vehicle as if an experienced driver was driving the vehicle, rather than simply following the target acceleration. The driving assistant apparatus 1 determines a scenario according to the driving state of the vehicle and determines the control method of the vehicle according to the scenario, thereby allowing the vehicle to be comfortably driven and increasing safety and energy efficiency.

The detection unit 11 may detect the driving information of a surrounding vehicle and the driving information of a host vehicle (hereinafter referred to as a ‘vehicle’). The detection unit 11 may detect the driving information of the surrounding vehicle and the driving information of the host vehicle using a plurality of sensors.

The detection unit 11 may detect the driving information such as the size, position, departure angle, or speed information of the surrounding vehicle traveling on the front, rear, left, and right sides of the vehicle. Here, the plurality of sensors may include sensors such as an infrared sensor, an ultrasonic sensor, a laser scanner, lidar, radar, a Global Positioning System (GPS) receiver, and a camera.

The detection unit 11 may detect the driving information of the vehicle using the plurality of sensors. For example, the speed, position, and steering angle of the vehicle may be detected using a speed sensor, a position sensor, a steering angle sensor, etc.

The scenario decision unit 12 may determine the driving state of the vehicle using the driving information of the surrounding vehicle and the driving information of the vehicle, and may decide the driving state of the vehicle as one of preset scenarios.

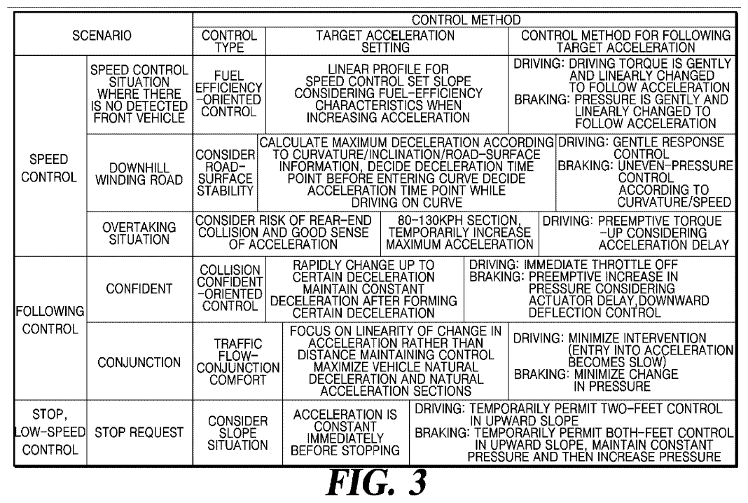

Here, the preset scenario means data on the driving state in which it is determined that the control of the vehicle is awkward when the existing driving assistant apparatus performs the SCC function (see FIG. 3). That is, the preset scenario is accumulated data of situations in which a driver felt uncomfortable when using the SCC.

The control method decision unit 13 may set the target acceleration of the vehicle in response to the scenario decided by the scenario decision unit 12, and may determine the control method for the driving control and the braking control of the vehicle following the target acceleration.

To be more specific, the control method decision unit 13 may decide a preset control type corresponding to the scenario decided by the scenario decision unit 12, and may calculate the target acceleration to correspond to the control type. The control method decision unit 13 may set the target acceleration corresponding to the control type, and may decide the control method for the driving control and the braking control of the vehicle to follow the target acceleration.

Here, the control type may be changed according to a driver's setting. For example, if a driver selects a sports mode or a comfort mode, the control type may be changed according to the mode selected by the driver. When the control type is changed, the target acceleration corresponding thereto is also changed. As a result, the control method for the driving control and the braking control of the vehicle following the target acceleration may also be changed.

The control unit 14 may control the vehicle based on the control method decided by the control method decision unit 13. To be more specific, the control unit 14 may control the stroke of an accelerator pedal and/or a brake pedal. The stroke of the accelerator pedal may be controlled by the control method of the driving control decided by the control method decision unit 13. Furthermore, the stroke of the brake pedal may be controlled by the control method of the braking control decided by the control method decision unit 13. The driving control and the braking control may be performed at the same time, or only a part thereof may be performed.

The control unit 14 may control the torque of an engine and/or brake. The control unit 14 controls the vehicle using two methods (stroke control and/or torque control), so that the driving assistant apparatus 1 of the present disclosure may be combined with various autonomous driving controllers. For example, in the case of an autonomous driving controller that does not use the stroke control of the accelerator pedal and/or brake pedal, the vehicle may be controlled by controlling the torque of the engine and/or brake.

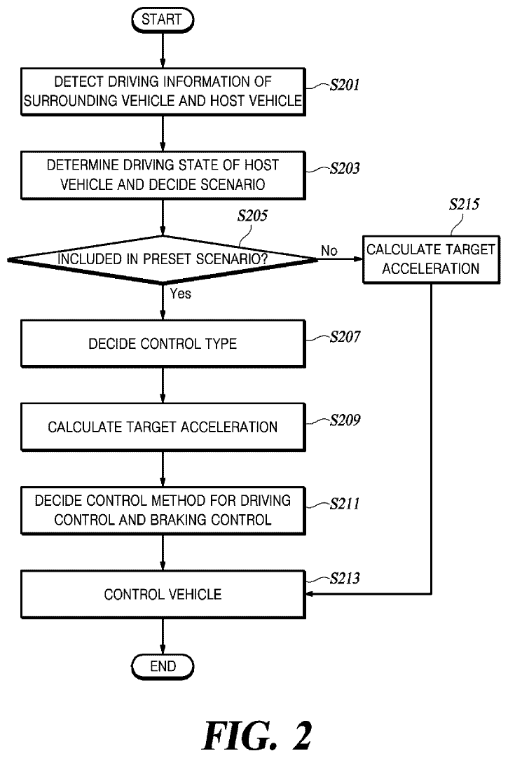

FIG. 2 is a flowchart showing a control method of a driving assistant apparatus according to an embodiment of the present disclosure.

Referring to FIG. 2, the control method of the driving assistant apparatus according to the present disclosure may include a step of detecting driving information of a surrounding vehicle and a host vehicle (S201). The detection unit 11 may detect the driving information of the surrounding vehicle and the driving information of the host vehicle using a plurality of sensors.

The scenario decision unit 12 may determine the driving state of the vehicle using the driving information of the surrounding vehicle and the driving information of the vehicle, and may decide the driving state of the vehicle as one of preset scenarios (S203).

When the driving state of the vehicle is decided as one of preset scenarios, the control method decision unit 13 may decide a preset control type corresponding to the scenario decided by the scenario decision unit 12 (S207).

The control method decision unit 13 may calculate target acceleration to correspond to the decided control type (S209). The control method decision unit 13 may set the target acceleration corresponding to the control type, and may decide the control method for the driving control and braking control of the vehicle, which controls the vehicle to follow the target acceleration (S211).

The control unit 14 may control the vehicle based on the control method decided by the control method decision unit 13 (S213). To be more specific, the control unit 14 may control the stroke of the accelerator pedal and/or brake pedal. Furthermore, the control unit 14 may control the torque of the engine and/or brake.

When the driving state of the vehicle is not included in the preset scenario, the control method decision unit 13 may calculate the target acceleration using the driving information of the surrounding vehicle and the driving information of the vehicle (S215). The control unit 14 may control the vehicle to follow the target acceleration. That is, when the driving state of the vehicle is not included in the preset scenario, the vehicle may be controlled like the existing driving assistant apparatus.

FIG. 3 is a table showing a specific embodiment of the driving assistant apparatus according to an embodiment of the present disclosure.

Referring to FIG. 3, the driving assistant apparatus of the present disclosure may include a plurality of preset scenarios. Here, the preset scenarios may include one or more of a vehicle-speed control situation, a front vehicle following control situation of the vehicle, and a stop control situation of the vehicle. The speed control situation may include a speed control situation in which there is no detected front vehicle, a downhill winding road, and an overtaking situation. The following control situation may include confident control and conjunction control situations.

The control method decision unit 13 may decide a preset control type corresponding to the scenario decided by the scenario decision unit 12, and may set a target acceleration to correspond to the control type. The control method decision unit 13 may set the target acceleration corresponding to the control type, and may decide the control method for the driving control and braking control of the vehicle, which controls the vehicle to follow the target acceleration. The control method according to six preset scenarios will be described below in detail.

When the scenario decision unit 12 decides that the driving state of the vehicle is the speed control situation in which there is no detected front vehicle, the control method decision unit 13 may decide the control type as a fuel efficiency-oriented control. In this case, the control method decision unit 13 may set the target acceleration by setting a linear profile for speed control and setting a slope to take into account fuel-efficiency characteristics when acceleration is increased. The control method decision unit 13 may decide the control method for the driving control and braking control to follow the target acceleration. The control method decision unit 13 may perform the driving control so that driving torque is gently and linearly changed to follow the target acceleration. Furthermore, the control method decision unit 13 may perform the braking control so that pressure is gently and linearly changed to follow the target acceleration. At this time, the driving control and the braking control may be simultaneously performed.

When the scenario decision unit 12 decides that the driving state of the vehicle is the downhill winding road situation, the control method decision unit 13 may decide the control type as a control taking into consideration road-surface stability. In this case, the control method decision unit 13 may calculate maximum deceleration based on a curvature, an inclination, and road-surface information, and may decide a deceleration time point before entering a curve and an acceleration time point while driving on the curve, thereby setting the target acceleration. The control method decision unit 13 may decide the control method for the driving control and braking control to follow the target acceleration. The control method decision unit 13 may perform the driving control in a gentle response control method. Furthermore, the control method decision unit 13 may perform braking control in an uneven pressure control method according to the curvature and speed. That is, left and right wheels may be controlled to have different pressures. At this time, the driving control and the braking control may be simultaneously performed.

When the scenario decision unit 12 decides that the driving state of the vehicle is the overtaking situation, the control method decision unit 13 may decide the control type as a control with the sense of acceleration taking into consideration the risk of collision of a surrounding vehicle from the rear. In this case, the control method decision unit 13 may set the target acceleration by temporarily increasing the maximum acceleration. For example, the target acceleration may be set such that the speed of the vehicle reaches 80 to 130 km/h. The control method decision unit 13 may decide the control method for the driving control and braking control to follow the target acceleration. The control method decision unit 13 may perform the driving control to preemptively torque-up in consideration of the delay in the acceleration of the vehicle. That is, upward deflection control may be temporarily performed. In this case, only the driving control may be performed without the braking control.

When the scenario decision unit 12 decides that the driving state of the vehicle is the confident control situation of the following control, the control method decision unit 13 may decide the control type as a collision stability-oriented control. This refers to a control that may give a driver a confident feeling about the following control. In this case, the control method decision unit 13 may set the target acceleration to maintain constant deceleration after rapidly changing speed up to a certain deceleration and forming the certain deceleration. The control method decision unit 13 may decide the control method for the driving control and braking control to follow the target acceleration. The control method decision unit 13 may perform the driving control in an immediate throttle off method. Furthermore, the control method decision unit 13 may take into consideration an actuator delay and perform the braking control to preemptively increase pressure. That is, downward deflection control may be performed. At this time, the driving control and the braking control may be simultaneously performed.

When the scenario decision unit 12 decides that the driving state of the vehicle is the conjunction control situation of the following control, the control method decision unit 13 may decide the control type so that the driving state of the vehicle is in conjunction with the traffic flow of surrounding vehicles. This refers to a control in which a driver may feel comfortable about the following control. In this case, the control method decision unit 13 may set the target acceleration by focusing on the linearity of a change in acceleration rather than the control for maintaining a distance. The control method decision unit 13 may set the target acceleration to maximize the natural deceleration and natural acceleration sections of the vehicle. The control method decision unit 13 may decide the control method for the driving control and braking control to follow the target acceleration. The control method decision unit 13 may minimize the intervention of the driving control. That is, the control may be made such that the entry into the acceleration situation becomes slow. Furthermore, the control method decision unit 13 may perform the braking control to minimize a change in braking pressure. At this time, the driving control and the braking control may be simultaneously performed.

When the scenario decision unit 12 decides that the driving state of the vehicle is a situation in which a stop request is made, the control method decision unit 13 may decide the control type in consideration of a slope. In this case, the control method decision unit 13 may set the target acceleration so that acceleration is constant immediately before stopping. The control method decision unit 13 may decide the control method for the driving control and braking control to follow the target acceleration. The control method decision unit 13 may perform the driving control in a manner that temporarily permits control to be made by both feet in an upward slope. Furthermore, the control method decision unit 13 may perform the braking control in a manner that temporarily permits control to be made by both feet in the upward slope. The control method decision unit 13 may perform the braking control such that a constant braking pressure is maintained and then the braking pressure is increased after stopping. At this time, the driving control and the braking control may be simultaneously performed.

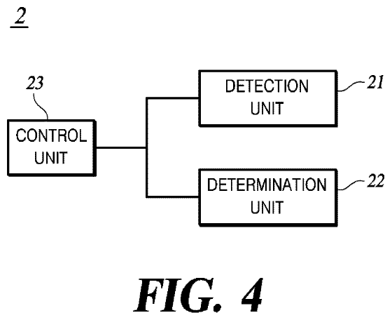

FIG. 4 is a block diagram showing the configuration of a driving assistant apparatus according to another embodiment of the present disclosure.

Referring to FIG. 4, the driving assistant apparatus 2 may include a detection unit 21, a determination unit 22, and a control unit 23. According to an exemplary embodiment of the present disclosure, driving assistant apparatus 2 may include a processor (e.g., computer, microprocessor, CPU, ASIC, circuitry, logic circuits, etc.) and an associated non-transitory memory storing software instructions which, when executed by the processor, provides the functionalities of the determination unit 22 and the control unit 23. Herein, the memory and the processor may be implemented as separate semiconductor circuits. Alternatively, the memory and the processor may be implemented as a single integrated semiconductor circuit. The processor may embody one or more processor(s).

The detection unit 21 may acquire information about a road on which the vehicle is driven. Here, the information about the road may include the inclination of the road on which the vehicle is driven, the curvature of the road, and the condition of a road surface. The condition of the road surface may include the friction of the road surface, the type of the road surface, etc. The detection unit 21 may detect other vehicles and objects around the vehicle.

The detection unit 21 may transmit the acquired information to the determination unit 22 and/or the control unit 23. The detection unit 21 may include one or more sensors so as to detect information about the road. The sensors may be Radio Detection And Ranging (RADAR), Light Detection And Ranging (LiDAR), a camera, etc.

The determination unit 22 decides the driving schedule of the vehicle based on the information about the road and/or the driving mode of the vehicle. The determination unit 22 may include a configuration that is the same as or corresponds to that of the scenario decision unit 12 and the control method decision unit 13 of the driving assistant apparatus 1 according to the above-described embodiment of the present disclosure.

The information about the road includes the inclination of the road, the curvature of the road, the condition of the road surface, etc. The determination unit 22 may receive the information about the road from the detection unit 21. The determination unit 22 may receive information about the road and the course of the vehicle from a navigation system installed in the vehicle. That is, the determination unit 22 may receive the information about the road from at least one of the detection unit 21 and the navigation system. However, the present disclosure is not necessarily limited thereto, and the information about the road may be obtained and used in various ways according to purposes and uses.

The driving mode of the vehicle means the function of changing and applying the driving system of the vehicle according to the driving situation such as the distribution of a vehicle's driving force, a change in shift time according to RPM control, or the intervention of a safety device. The driving mode of the vehicle may include a comfort mode, a sports mode, an eco mode, a smart mode, a custom mode, a snow mode, etc. The comfort mode refers to the driving mode that controls the vehicle so that a passenger can feel maximum comfort in terms of the accelerating force and braking force of the vehicle. The sports mode refers to the driving mode that controls the vehicle to provide a driver with an optimum sense of speed by maintaining high RPM, increasing acceleration, and making the response of the engine quick. The eco mode refers to the driving mode that controls the vehicle to minimize fuel consumption due to unnecessary acceleration by controlling the output and shift time of the vehicle. The smart mode refers to the driving mode that controls the vehicle based on the identified driver's driving pattern or habits. The custom mode refers to the driving mode in which a driver personally sets several functions of the vehicle according to driving environment and thereby controls the vehicle. The snow mode refers to the driving mode that controls the vehicle to allow the vehicle to be safely driven on a slippery road such as a snowy road or an icy road. However, it should be noted that the driving modes used in the driving assistant apparatus 2 and the control method thereof according to the present disclosure are not necessarily limited thereto. The determination unit 22 may decide the driving schedule of the vehicle based on the driving mode of the vehicle.

The driving schedule of the vehicle may include a vehicle's deceleration time point, acceleration time point, acceleration level, braking time point, braking level, etc. In this regard, the deceleration time point of the vehicle may include at least one of an acceleration command release (throttle off) time point or a coasting entry time point, and the acceleration level and the braking level may mean the magnitudes of acceleration and braking force, respectively.

The determination unit 22 may decide the driving schedule of the vehicle including the vehicle's deceleration time point, acceleration time point, acceleration level, braking time point, and braking level based on the inclination of the road, the curvature of the road, the condition of the road surface, and the driving mode of the vehicle. Thus, this can provide a vehicle's passenger with the same comfort as if an experienced driver drove the vehicle, and can efficiently drive the vehicle in terms of energy or the like.

The control unit 23 may control the vehicle based on the driving schedule of the vehicle decided by the determination unit 22. The control unit 23 may receive information about the driving schedule of the vehicle from the determination unit 22. Although it is described in the present disclosure that the determination unit 22 decides the driving schedule of the vehicle and the control unit 23 controls the vehicle based on the decided schedule, the control unit 23 may directly decide the driving schedule of the vehicle and then control the vehicle based on the decided schedule according to purposes and uses, without being necessarily limited thereto. In this case, the control unit 23 may receive information about the road from the detection unit 21 and/or the navigation system, and may decide the driving schedule of the vehicle based on the information about the road and/or the driving mode of the vehicle.

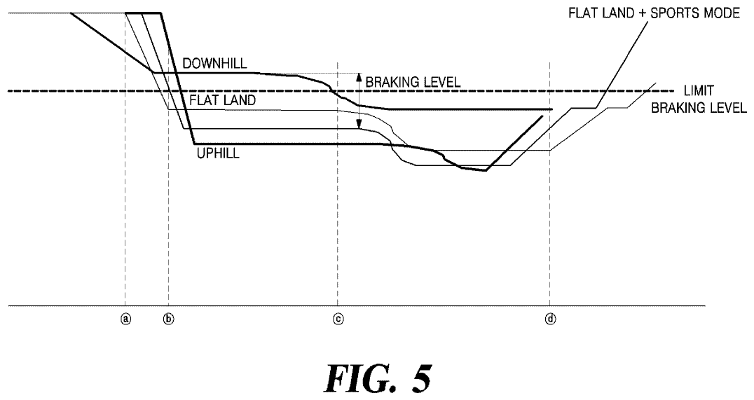

FIG. 5 is a diagram illustrating a method of deciding a driving schedule of a vehicle according to another embodiment of the present disclosure.

Referring to FIGS. 4 and 5, the method of deciding the driving schedule of the vehicle based on the information about the road and/or the driving mode of the vehicle will be specifically described.

The determination unit 22 may decide the acceleration command release time point based on the inclination of the road on which the vehicle is driven and/or the driving mode of the vehicle. For example, when the vehicle is expected to travel on a downhill path, the determination unit 22 may decide the driving schedule to release the vehicle's acceleration command before the acceleration command release time point \textcircled{a} (see FIG. 5) on a flat land. In contrast, when the vehicle is expected to travel on an uphill path, the determination unit 22 may decide the driving schedule to release the acceleration command of the vehicle after the acceleration command release time point on the flat land. In order to provide a driver and a passenger with an optimum sense of speed when the vehicle is driven on the flat land in the sports mode, the determination unit 22 may decide the driving schedule to release the acceleration command of the vehicle after the acceleration command release time point in the general driving mode (flat land). Although only the control method in the sports mode as one example of the driving modes of the vehicle has been specifically described in the present disclosure, it should be noted that the determination unit 22 may decide the driving schedule of the vehicle to be fit for the purpose of each driving mode applicable to the vehicle. The determination unit 22 may decide the acceleration command release time point based on the slope of the road on which the vehicle is driven or is scheduled to be driven.

The determination unit 22 may decide the coasting entry time point based on the inclination of the road on which the vehicle is driven and/or the driving mode of the vehicle. For example, when the vehicle is scheduled to travel on the downhill path, the determination unit 22 may decide the driving schedule so that the vehicle enters the coasting before the coasting entry time point \textcircled{b} (see FIG. 5) on the flat land. In contrast, when the vehicle is scheduled to travel on the uphill path, the determination unit 22 may decide the driving schedule so that the vehicle enters the coasting after the coasting entry time point on the flat land. In order to provide a driver and a passenger with an optimum sense of speed when the vehicle is driven on the flat land in the sports mode, the determination unit 22 may decide the driving schedule so that the vehicle enters the coasting after the coasting entry time point in the general driving mode (flat land). The determination unit 22 may decide the coasting entry time point based on the slope of the road on which the vehicle is driven or is scheduled to be driven.

The determination unit 22 may decide a braking time point based on the inclination of the road on which the vehicle is driven and/or the driving mode of the vehicle. For example, when the vehicle is scheduled to travel on the downhill path, the determination unit 22 may decide the driving schedule to brake the vehicle before the braking time point \textcircled{c} (see FIG. 5) on the flat land. In contrast, when the vehicle is scheduled to travel on the uphill path, the determination unit 22 may decide the driving schedule so that the vehicle is braked after the braking time point on the flat land. In order to provide a driver and a passenger with an optimum sense of speed when the vehicle is driven on the flat land in the sports mode, the determination unit 22 may decide the driving schedule so that the vehicle is braked after the braking time point in the general driving mode (flat land). The determination unit 22 may decide the braking time point based on the slope of the road on which the vehicle is driven or is scheduled to be driven.

The determination unit 22 may decide a braking level based on the inclination of a road on which the vehicle is driven and/or the driving mode of the vehicle. When the vehicle is scheduled to travel on the downhill path, the determination unit 22 may decide the driving schedule so that the vehicle is braked at the braking level higher than the braking level on the flat land (see FIG. 5). Here, the expression “the braking level is higher” means that the vehicle is controlled to generate a relatively larger braking force. When the vehicle is scheduled to travel on the uphill path, the determination unit 22 may decide the driving schedule so that the vehicle is braked at the braking level lower than the braking level on the flat land. In order to provide a driver and a passenger with an optimum sense of speed when the vehicle is driven on the flat land in the sports mode, the determination unit 22 may decide the driving schedule so that the vehicle is braked at the braking level lower than the braking level in the general driving mode (flat land). The determination unit 22 may decide the braking level based on the slope of the road on which the vehicle is driven or is scheduled to be driven. The determination unit 22 may decide the braking level of the vehicle based on a limit braking level (see FIG. 5) according to the inclination of the road and/or the condition of the road surface.

The determination unit 22 may decide an acceleration time point based on the inclination of a road on which the vehicle is driven and/or the driving mode of the vehicle. For example, when the vehicle is scheduled to travel on the downhill path, the determination unit 22 may decide the driving schedule so that the vehicle is accelerated after the acceleration time point \textcircled{d} (see FIG. 5) on the flat land. In contrast, when the vehicle is scheduled to travel on the uphill path, the determination unit 22 may decide the driving schedule so that the vehicle is accelerated before the acceleration time point on the flat land. In order to provide a driver and a passenger with an optimum sense of speed when the vehicle is driven on the flat land in the sports mode, the determination unit 22 may decide the driving schedule so that the vehicle is accelerated before the acceleration time point in the general driving mode (flat land). The determination unit 22 may decide the acceleration time point based on the slope of the road on which the vehicle is driven or is scheduled to be driven.

The determination unit 22 may decide an acceleration level based on the inclination of a road on which the vehicle is driven and/or the driving mode of the vehicle. When the vehicle is scheduled to travel on the downhill path, the determination unit 22 may decide the driving schedule so that the vehicle is accelerated at the acceleration level lower than the acceleration level on the flat land. Here, the expression “the acceleration level is higher” means that the vehicle is controlled to generate relatively higher acceleration. When the vehicle is scheduled to travel on the uphill path, the determination unit 22 may decide the driving schedule so that the vehicle is accelerated at the acceleration level higher than the acceleration level on the flat land. In order to provide a driver and a passenger with an optimum sense of speed when the vehicle is driven on the flat land in the sports mode, the determination unit 22 may decide the driving schedule so that the vehicle is accelerated at the acceleration level higher than the acceleration level in the general driving mode (flat land). The determination unit 22 may decide the acceleration level based on the slope of the road on which the vehicle is driven or is scheduled to be driven.

The determination unit 22 may decide the driving schedule of the vehicle based on the curvature of a road or whether the vehicle is scheduled to be driven on a curved path. The determination unit 22 may decide the driving schedule such as the acceleration command release time point, the coasting entry time point, the braking time point, the braking level, the acceleration time point and the acceleration level, based on the curvature of the road or whether the vehicle is scheduled to be driven on the curved path in a method that is equal or similar to the above-described method of deciding the driving schedule of the vehicle based on the inclination of the road. Since this will be clearly understood by those skilled in the art, a duplicated description thereof will be omitted. The determination unit 22 may decide the driving schedule of the vehicle based on the curvature of the road as well as a time point when the vehicle enters the curved path.

The determination unit 22 may decide the driving schedule of the vehicle by considering several factors for deciding the above-described driving schedule of the vehicle in combination or individually.

As an example, when the vehicle is scheduled to drive on a downhill curved path, the determination unit 22 may decide the driving schedule so that the acceleration command of the vehicle is released and the vehicle enters coasting before the acceleration command release time point and the coasting entry time point on the flat land, thus preventing a braking force from being intervened in advance. Subsequently, the braking level of the vehicle may be determined based on the inclination of the road and the condition of the road surface. In this case, when escaping from the curved path, the driving schedule may be decided so that the vehicle is not particularly accelerated.

As another example, when the vehicle is scheduled to drive on a downhill-flat-uphill curved path, the determination unit 22 may decide the driving schedule so that the vehicle releases the acceleration command and coasts on the downhill path. The determination unit 22 may decide the driving schedule so that the vehicle is braked on the flat land. The determination unit 22 may decide the acceleration time point and the acceleration level based on a point where the uphill path starts and the condition of the road surface when escaping from the curved path. However, the present disclosure is not necessarily limited thereto, and the driving schedule may be decided differently based on information about the road and/or the driving mode of the vehicle depending on the situation.

As such, the driving assistant apparatus 2 according to an embodiment of the present disclosure decides the driving schedule of the vehicle based on the information about the road and/or the driving mode of the vehicle, thus improving energy efficiency due to the efficient use of the speed and acceleration of the vehicle, and providing a high level of comfort to a passenger due to the smooth driving of the vehicle. Furthermore, it is possible to prevent a potential risk from occurring due to sudden braking or the like.

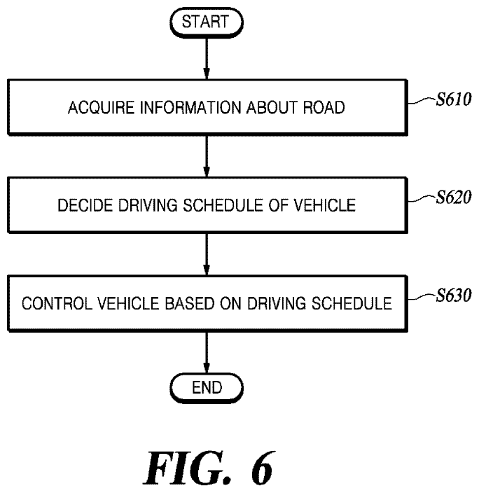

FIG. 6 is a flowchart showing a control method of a driving assistant apparatus according to another embodiment of the present disclosure.

The detection unit 21 acquires information about a road (S610). The detection unit 21 may acquire the information about the road on which the vehicle is driven. Here, the information about the road may include the inclination of the road on which the vehicle is driven, the curvature of the road, and the condition of a road surface. The condition of the road surface may include the friction of the road surface, the type of the road surface, etc. The detection unit 21 may detect other vehicles and objects around the vehicle. The detection unit 21 may transmit the acquired information to the determination unit 22 and/or the control unit 23. The detection unit 21 may include one or more sensors so as to detect information about the road. The sensors may be Radio Detection And Ranging (RADAR), Light Detection And Ranging (LiDAR), a camera, etc.

The determination unit 22 decides the driving schedule of the vehicle (S620). The determination unit 22 decides the driving schedule of the vehicle based on the information about the road and/or the driving mode of the vehicle. The determination unit 22 may receive the information about the road from at least one of the detection unit 21 and the navigation system. The determination unit 22 may decide the driving schedule of the vehicle including the vehicle's deceleration time point, acceleration time point, acceleration level, braking time point, and braking level based on the inclination of the road, the curvature of the road, the condition of the road surface, and the driving mode of the vehicle. Thus, this can provide a vehicle's passenger with the same comfort as if an experienced driver drove the vehicle, and can efficiently drive the vehicle in terms of energy or the like. However, as described above, it should be noted that the determination unit 22 does not necessarily decide the driving schedule of the vehicle but the control unit 23 may directly decide the driving schedule of the vehicle and then control the vehicle.

The control unit 23 controls the vehicle based on the driving schedule (S630). The control unit 23 may receive information about the driving schedule of the vehicle from the determination unit 22, and may control the vehicle based on the information.

Each component of the apparatus or method according to the present disclosure may be implemented as hardware or software, or a combination of hardware and software. Furthermore, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an embodiment of the present disclosure. In other words, since it is apparent to those skilled in the art that an order described in the flowchart/timing diagram may be changed or one or more processes may be executed in parallel without departing from the essential characteristics of an embodiment of the present disclosure, the flowchart/timing diagram is not limited to a time-series order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method of controlling a driving assistant apparatus, the method comprising:
a detection step of detecting driving information of a surrounding vehicle and driving information of a host vehicle;
a scenario deciding step of determining a driving state of the host vehicle using the driving information of the surrounding vehicle and the driving information of the host vehicle, and determining whether the driving state of the host vehicle is decided as a preset scenario of preset scenarios;
a control method deciding step of setting a target acceleration of the host vehicle in response to determination that the driving state of the host vehicle is decided as the preset scenario, and determining a control method for driving control and braking control of the host vehicle following the target acceleration; and
a control step of controlling the host vehicle based on the determined control method.

2. The method of claim 1, wherein the preset scenarios comprise one of a vehicle-speed control situation, a front vehicle following control situation of the vehicle, and a stop control situation of the vehicle.

3. The method of claim 1, wherein the control method deciding step comprises:
a step of deciding a preset control type corresponding to the decided preset scenario, and calculating the target acceleration to correspond to the preset control type.

4. The method of claim 3, wherein the preset control type is changeable according to a driver's setting.

5. The method of claim 1, wherein the control step of controlling the vehicle comprises; controlling a stroke of an accelerator pedal or a brake pedal.

6. The method of claim 1, wherein the control step of controlling the vehicle comprises; controlling a torque of an engine or a brake.

7. The method of claim 1, wherein the control method deciding step comprising:
in response to determination that the driving state of the host vehicle is not decided as the preset scenario, setting the target acceleration of the host vehicle using the driving information of the surrounding vehicle and the driving information of the host vehicle.

8. A driving assistant apparatus comprising:
a detection unit for detecting driving information of a surrounding vehicle and driving information of a host vehicle;
a scenario decision unit for determining a driving state of the host vehicle using the driving information of the surrounding vehicle and the driving information of the host vehicle, and determining the driving state of the host vehicle is decided as a preset scenario of preset scenarios;
a control method decision unit for setting target acceleration of the host vehicle in response to determination that the driving state of the host vehicle is decided as the preset scenario, and determining a control method for driving control and braking control of the host vehicle following the target acceleration; and
a control unit for controlling the host vehicle based on the determined control method decided by the control method decision unit.

9. The apparatus of claim 8, wherein the scenario decision unit stores the preset scenarios of a vehicle-speed control situation, a front vehicle following control situation of the vehicle, and a stop control situation of the vehicle.

10. The apparatus of claim 8, wherein the control method decision unit decides a preset control type corresponding to the decided preset scenario, and calculates the target acceleration to correspond to the preset control type.

11. The apparatus of claim 10, wherein the preset control type is changeable according to a driver's setting.

12. The apparatus of claim 8, wherein the control unit controls a stroke of an accelerator pedal or a brake pedal.

13. The apparatus of claim 8, wherein the control unit controls a torque of an engine or a brake.

14. The apparatus of claim 8, wherein in response to determination that the driving state of the host vehicle is not decided as the preset scenario, the control method decision unit sets the target acceleration of the host vehicle using the driving information of the surrounding vehicle and the driving information of the host vehicle.

15. A driving assistant apparatus comprising:
a determination unit for determining a driving schedule of a vehicle based on information about a road on which the vehicle is driven; and
a control unit for controlling the vehicle based on the driving schedule,
wherein the information about the road comprises one of an inclination of the road, a curvature of the road, a condition of a road surface, and a combination thereof.

16. The apparatus of claim 15, wherein the determination unit decides the driving schedule of the vehicle based on a driving mode of the vehicle.

17. The apparatus of claim 16, wherein the driving mode comprises a comfort mode, a sports mode, an eco mode, a smart mode, a custom mode, and a snow mode.

18. The apparatus of claim 16, wherein the driving schedule comprises one of a deceleration time point, a acceleration time point, an acceleration level, a braking time point, a braking level of the vehicle, and a combination thereof.

19. The apparatus of claim 18, wherein the deceleration time point comprises at least one of an acceleration command release time point or a coasting entry time point.

20. The apparatus of claim 18, wherein the determination unit decides the braking level based on one of an inclination of a road, a condition of a road surface, and a combination thereof.
